(19) United States
(12) Patent Application Publication
(10) Pub. No.: US 2013/0073705 A1
(43) Pub. Date: Mar. 21, 2013

(54) MANAGING A HOME AREA NETWORK

(71) Applicant: Lance Hester, Saint Louis Park, MN (US)

(72) Inventor: Lance Hester, Saint Louis Park, MN (US)

(73) Assignee: HONEYWELL INTERNATIONAL INC., Morristown, NJ (US)

(21) Appl. No.: 13/236,810

(22) Filed: Sep. 20, 2011

(51) Int. Cl. G06F 15/173

(52) U.S. Cl. 709/223

(57) ABSTRACT

Managing a home area network is described herein. One method includes receiving operating information associated with a device in a home area network, and determining a profile associated with the device based, at least in part, on the operating information.

### TECHNICAL FIELD

The present disclosure relates to managing a home area network.

### BACKGROUND

A Home Area network (HAN) can be, for example, a network that connects (e.g., is used for communication between) devices in a structure, such as, for example, a home, apartment, or office. A HAN can be an important part of energy management in many types of structures, including, but not limited to, homes, apartments, and/or offices. For example, a HAN can be an extension of energy metering infrastructure and can facilitate two-way communication between devices (e.g., HAN devices) in a structure, users, and/or a utility (e.g., a power company). Devices in a HAN can include computing devices, appliances, programmable communicating thermostats (PCTs), and many others.

HANs can empower a user (e.g., an energy consumer) to participate in energy conservation programs and/or assist a utility in managing peak electric demand. For example, a HAN device can include a display informing a user of the user's power usage, which can motivate the user to make power consumption decisions based on tiered rate structures. Structures equipped with one or more HANs can assist a utility in addressing peak energy demand with monetary savings passed on to the user.

Devices in a HAN may be configured with a particular profile (e.g., ZIGBEE Smart Energy Profile (ZSE)). A profile of a HAN device can, for example, be pre-loaded upon purchase of the HAN device and/or can be downloaded to the HAN device (e.g., after purchase). A HAN device profile may have a number of different versions (e.g., firmware versions). However, some versions of HAN device profiles may not be compatible with other versions. For example, ZSE version 2.0 may not be compatible with ZSE version 1.1. HAN devices configured with incompatible profiles may not be able to participate in the same HAN network. Also, utilities, service providers, customers and/or other entities may not be aware of the identity of one or more profiles existing in a HAN device. Moreover, these entities may not be aware of whether those profile(s) are actively being used by the device in a HAN.

Accordingly, such entities may not be aware of whether a device is participating in a HAN and/or may not be able to configure a HAN device with a different (e.g., upgraded) profile. Further, such entities may not be aware of what type(s) of device(s) can be added to a HAN, a number of devices that can be added to a HAN before performance of the HAN may degrade, and/or smart energy programs that can be marketed to users and/or managers of the HAN.

Additionally, such entities may not be aware of potential points in a HAN where functionality restrictions may exist (e.g., where one or more devices in the HAN may be incompatible). Accordingly, a user and/or manager of the HAN may have to purchase new and/or upgraded hardware to address any potential application layer functional inadequacies associated with the HAN.

### BRIEF DESCRIPTION OF THE DRAWINGS

FIG. 1 illustrates a system for managing a home area network in accordance with one or more embodiments of the present disclosure.

FIG. 2 illustrates another system for managing a home area network in accordance with one or more embodiments of the present disclosure.

FIG. 3 illustrates a method for managing a home area network in accordance with one or more embodiments of the present disclosure.

### DETAILED DESCRIPTION

Managing a home area network (HAN) is described herein. For example, one or more embodiments include receiving operating information associated with a device in a home area network, and determining a profile associated with the device based, at least in part, on the operating information.

Embodiments of the present disclosure can determine whether a HAN device is participating in a HAN. Additionally, embodiments of the present disclosure can determine a profile version associated with the HAN device.

Embodiments of the present disclosure can be used to migrate devices of the HAN to upgraded profiles. Further, embodiments of the present disclosure can be used by a customer, utility, and/or service provider to determine, for example, what type(s) of device(s) can be added to a HAN, a number of devices that can be added to a HAN before performance of the HAN may degrade, and/or smart energy programs that can be marketed to users and/or managers of the HAN.

Additionally, embodiments of the present disclosure can identify potential points in a HAN where functionality restrictions may exist (e.g., where one or more devices in the HAN may be incompatible). Accordingly, embodiments of the present disclosure can inform a user and/or manager of the HAN who may have to purchase new and/or upgraded hardware to address any potential application layer functional inadequacies associated with the HAN.

In the following detailed description, reference is made to the accompanying drawings that form a part hereof. The drawings show by way of illustration how one or more embodiments of the disclosure may be practiced. These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

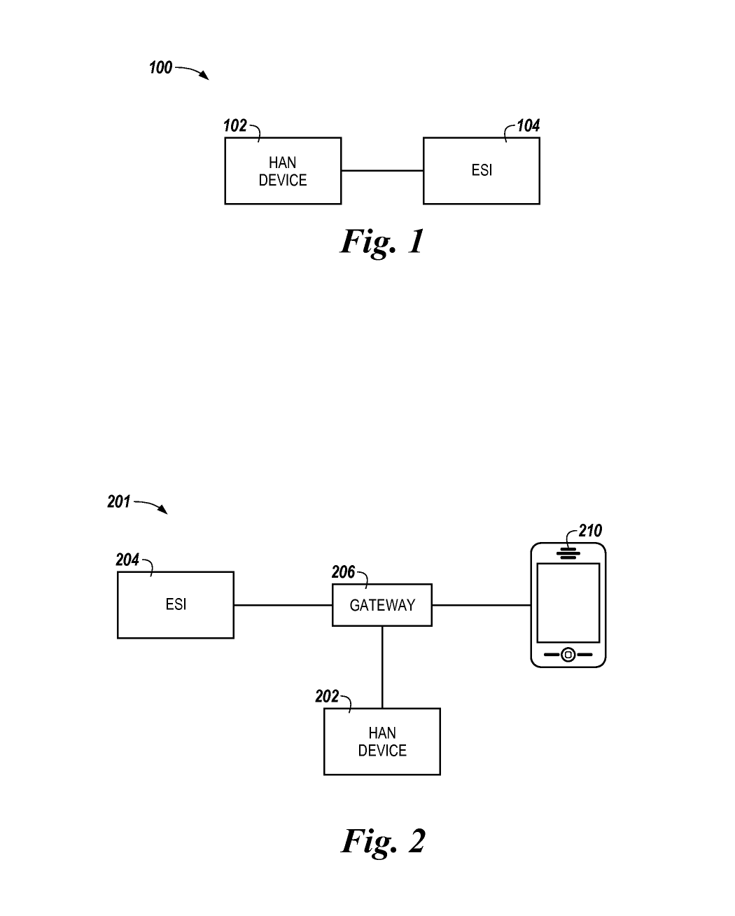

The figures herein follow a numbering convention in which the first digit or digits correspond to the drawing figure number and the remaining digits identify an element or component in the drawing. Similar elements or components between different figures may be identified by the use of similar digits. For example, 104 may reference element “04” in FIG. 1, and a similar element may be referenced as 204 in FIG. 2.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

As used herein, “a” or “a number of” something can refer to one or more such things. For example, “a number of HAN devices” can refer to one or more HAN devices.

FIG. 1 illustrates a system 100 for managing a home area network (HAN) in accordance with one or more embodiments of the present disclosure. As shown in FIG. 1, system 100 includes a HAN device 102 communicatively coupled (e.g., by the HAN) to an Energy Service Interface (ESI) 104. A communicative coupling can include wired and/or wireless connections and/or networks such that data can be transferred in any direction between HAN device 102 and ESI 104. Accordingly, system 100 can be and/or be a part of a HAN.

System 100 can be in and/or associated with one or more structures. A structure can be any structure capable of accommodating a HAN and/or HAN device. For example, a structure can be a house, an office building, an apartment complex, and/or a hospital, among other types of structures. Structure can also refer to subsets of larger structures. For example, a structure can include a room, an office, a wing, a walk-in freezer, and/or a hallway, as well as combinations and/or portions of these examples and/or others. Embodiments of the present disclosure do not limit structures to man-made structures; rather, a structure can be any area having a capability of accommodating one or more HANs and/or HAN devices.

HAN device 102 can be any device configured to participate in a HAN. Although one HAN device is shown in FIG. 1, embodiments of the present disclosure can include any number of HAN devices. A non-inclusive list of example HAN devices includes smart sockets, programmable communicating thermostats (PCTs), energy displays, ESIs, gateway devices, load control modules, electricity meters, natural gas meters, air conditioning units, heat pumps, and a variety of adapters and outlets, among many other devices.

ESI 104 can be a secure interface to a premises communications network (e.g., a HAN device configured to manage a HAN). For example, ESI 104 can be and/or be a part of a utility electric meter and/or a gateway device. In HAN networks, HAN devices may register with and/or be authenticated by an ESI (e.g., ESI 104). In a HAN, an ESI (e.g., ESI 104) can be considered to be a “master” device, and additionally, a HAN that is considered to be “on” can refer to a condition that an ESI managing the HAN is in operation. For example, a HAN can consist of a single ESI (e.g., ESI 104) and a number of HAN devices (e.g., HAN device 102) can associate and/or join the HAN managed by the ESI (e.g., the HAN devices can register under the ESI).

ESI 104 can facilitate a number of energy applications such as, for example, remote load control, demand response, monitoring and/or control of distributed energy resources (DERs), in-home display of energy usage, reading of energy and non-energy meters, Plug-in Electric Vehicle (PEV) charging an/or roaming coordination, among other energy applications. Additionally, ESI 104 can provide auditing and/or logging functions that record communications to and/or from HAN devices. Further, ESI 104 can secure communications between HAN devices registered (e.g., commissioned) on its network and/or enrolled in a service provider program.

Although one ESI is illustrated in FIG. 1, system 100 can include any number of ESIs. For example, a second ESI can be located in a gateway device in the HAN. Further, HAN devices can include any number of ESIs. An example of a system that includes multiple ESIs will be further described herein (e.g., in connection with FIG. 2).

HAN device 102 and/or ESI 104 can be and/or include a computing device including a processor and a memory (not shown in FIG. 1). The memory can be coupled to the processor and can be volatile or nonvolatile memory. The memory can also be removable (e.g., portable) memory, or non-removable (e.g., internal) memory. For example, the memory can be random access memory (RAM) (e.g., dynamic random access memory (DRAM), and/or phase change random access memory (PCRAM)), read-only memory (ROM) (e.g., electrically erasable programmable read-only memory (EEPROM), and/or compact-disk read-only memory (CD-ROM)), flash memory, a laser disk, a digital versatile disk (DVD), and/or other optical disk storage), and/or a magnetic medium such as magnetic cassettes, tapes, or disks, among other types of memory.

Further, although the memory can be located in HAN device 102 and/or ESI 104, embodiments of the present disclosure are not so limited. For example, the memory can also be located internal to another computing resource (e.g., enabling computer readable instructions to be downloaded over the Internet or another wired or wireless connection).

The memory can store executable instructions, such as, for example, computer readable instructions (e.g., software), for managing a HAN in accordance with one or more embodiments of the present disclosure. For example, the memory can store executable instructions for determining a profile associated with HAN device 102 and/or ESI 104 based, at least in part, on operating information associated with HAN device 102 and/or ESI 104, in accordance with one or more embodiments of the present disclosure. Additionally, the memory can store the determined profile.

The processor can execute the executable instructions stored in the memory to manage a HAN in accordance with one or more embodiments of the present disclosure. For example, the processor can execute the executable instructions stored in the memory to determine a profile associated with HAN device 102 and/or ESI 104 based, at least in part, on operating information associated with HAN device 102 and/or ESI 104, in accordance with one or more embodiments of the present disclosure.

ESI 104 can include and/or be communicatively coupled to one or more displays. A display may include, for example, a liquid crystal display (LCD), an active matrix liquid crystal display (AMLCD), a computer monitor, a television, a plasma display, a cathode ray tube (CRT) display, a light-emitting diode (LED) display, a digital light processing (DLP) display, a surface-conduction electron-emitter display (SED), a field emission display (FED), and/or a variety of other methods for electronically displaying images.

ESI 104 can execute executable instructions to determine a profile associated with ESI 104. Additionally and/or alternatively, ESI 104 can determine a participation status of ESI 104 in a HAN (e.g., whether ESI 104 is actively participating in a HAN). For example, ESI 104 can extract a profile and/or firmware version using an application service that reveals device features. Additionally and/or alternatively, ESI 104 can extract values from a startup parameters database and/or a table stored in the memory of ESI 104. Additionally and/or alternatively, ESI 104 can issue a device request message (e.g., a feature, function, and/or attribute request message) in order to determine pedigree information associated with ESI 104 from a static device information database stored in the memory of ESI 104.

ESI 104 can display the determined profile and/or participation status of ESI 104. In an example, ESI 104 can include an LED that flashes to indicate that a profile is active and/or available. Continuing in the example, the LED can glow dimly (e.g., at less than full brightness) to indicate that the profile is available but ESI 104 is not actively participating in a HAN.

Additionally and/or alternatively, HAN device 102 can include a display. For example, HAN device 102 can be a programmable communicating thermostat (PCT) having an LCD display. In this example, HAN device 102 can display a profile associated with HAN device 102 determined by, for example, the methods discussed above in connection with determining a profile associated with ESI 104 (e.g., by extracting a profile and/or firmware using an application service that reveals device features, etc). Additionally and/or alternatively, HAN device 102 can display its participation status in a HAN in a manner analogous to that previously discussed, and/or, for example, via a text-based notification on its display.

Additionally and/or alternatively, ESI 104 can determine and/or display a profile (e.g., a profile version and/or participation status) associated with HAN device 102. As previously discussed, HAN device 102 can be required to register with and/or be authenticated by ESI 104. During the registration process, device information (e.g., profile information and/or firmware version) can be exchanged between HAN device 102 and ESI 104. Device information associated with HAN device 102 can be stored in the memory of ESI 104, and displayed by ESI 104 (e.g., displayed in a manner analogous to that previously discussed). ESI 104 can also display a participation status of HAN device 102 in the HAN. For example, it can be presumed that because HAN device 102 and ESI 104 are able to communicate via their communicative coupling, HAN device 102 is actively participating in the HAN (e.g., the HAN managed by ESI 104).

Similarly, HAN device 102 can determine and/or display a profile (e.g., a firmware version and/or participation status) associated with ESI 104. For example, ESI 104 may not include a display. HAN device 102 can receive a profile associated with ESI 104 resulting from, for example, a service discovery application query and/or a device attributes request sent from HAN device 102 to ESI 104. HAN device 102 can store the received profile associated with ESI 104 in memory and/or can display the profile, for example, in a manner analogous to that previously discussed. It can be presumed that because HAN device 102 and ESI 104 are able to communicate via their communicative coupling that both devices are actively participating in the same HAN.

FIG. 2 illustrates a system 201 for managing a HAN in accordance with one or more embodiments of the present disclosure. As shown in FIG. 2, system 201 includes a gateway device communicatively coupled to an ESI 204, a HAN device 202, and a browser-enabled device 210.

HAN device 202 and ESI 204 can be, for example, analogous to HAN device 102 and ESI 104, respectively, previously discussed in connection with FIG. 1. Browser-enabled device 210 can be, for example, a computing device and/or a mobile device (e.g., a cellular telephone, personal digital assistant (FDA), etc). In a manner analogous to that previously discussed in connection with FIG. 1, ESI 204, gateway device 206, and/or HAN device 202 can also be and/or be a part of a computing device having a processor configured to execute executable instructions stored in memory.

Gateway device 206 can determine and/or display profiles and/or participation statuses of multiple devices (e.g., ESI 204 and/or HAN device 202) because, for example, gateway device 206 can participate in multiple HANs. Additionally and/or alternatively gateway device 206 can display an amount of HANs in which gateway device 206 is participating. Determining and/or displaying a profile and/or a participation status of a HAN device can be done in a manner analogous to that previously discussed in connection with FIG. 1.

Gateway device 206 can assume one or more roles in a HAN (e.g., assume one or more roles simultaneously in a HAN). For example, gateway device 206 can manage a first HAN (e.g., act as an ESI in a first HAN) and/or can act as a registered HAN device under another ESI in a second HAN. Although not shown in FIG. 2, gateway device 206 can itself include one or more ESIs and can thus manage one or more HANs.

Gateway device 206 can include a display, for example, analogous to one or more displays previously discussed in connection with FIG. 1. In an example in which gateway device 206 includes a display, gateway device 206 can display a profile and/or a participation status of a number of devices in a HAN in which it participates (e.g., ESI 204 and/or HAN device 202).

Although displays are discussed herein to communicate profile and/or participation status with respect to a number of devices, embodiments of the present disclosure do not limit any of the devices discussed herein to communicating profile(s) and/or status(es) via one or more displays. Rather, information can additionally and/or alternatively be communicated by any number of other means including, for example, audio (e.g., through a number of electroacoustic transducers).

As previously discussed, gateway device 206 can act as a HAN device registered under an ESI (e.g., ESI 204) in a HAN. Gateway device 206 can receive profile information associated with one or more HAN devices (e.g., HAN device 202 and/or ESI 204) in response to a request sent by gateway device 206 to the HAN devices (e.g., device attributes request, service discovery request, etc). Gateway device 206 can store the received profile and/or participation statuses of the HAN devices in memory.

As previously discussed, gateway device 206 can act as an ESI under which one or more HAN devices (e.g., HAN device 202) can be registered. Gateway device 206 can receive profile(s) associated with one or more HAN devices in the HAN (e.g., HAN device 202) upon registration and/or commission of the devices under the gateway device 206. Additionally, gateway device 206 can store the received profile(s) in memory.

Gateway device 206 can alternatively and/or additionally communicate the received profile(s) and/or participation status(es) to another device (e.g., browser-enabled device 210). As shown in FIG. 2, browser-enabled device 210 can include a display configured to display a profile and/or participation status of any number of devices participating in one or more HANs.

Gateway device 206 can process the received profile and/or participation status of any number of devices participating in one or more HANs and determine what possible profile(s) a structure can support. For example, gateway device 206 can inform a customer, utility, and/or service provider that the structure is capable of supporting HAN devices having a first profile (e.g. ZSE 1.0) in a first HAN, and HAN devices having a second (e.g., updated) profile (e.g., ZSE 2.0) in a second HAN.

As previously discussed, gateway device 206 can act as an ESI in a HAN. Continuing in the example, upon processing of the profile and/or participation status of any number of devices participating in a HAN managed by gateway device 206, gateway device 206 can track the progress of a firmware upgrade to a number of HAN devices managed by gateway device 206. Upgrade progress can be communicated by gateway device 206 to a utility, customer, and/or service provider, among others. Gateway device 206 can provide a notification associated with, for example, progress and/or a completion of the upgrade. Notifications can include a visual display on a display of gateway device 206, a display of another device in the HAN (e.g., HAN device 202) and/or another device (e.g., browser-enabled device 210), among others. In an example, a notification can include a logical graph representation associated with an upgrade while the upgrade is occurring and/or upon completion of the upgrade.

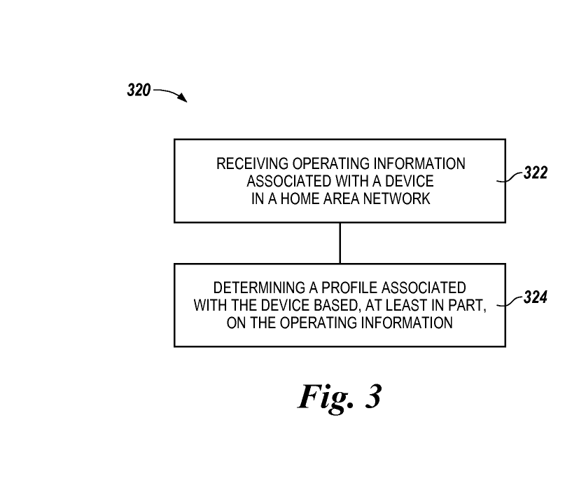

FIG. 3 illustrates a method 320 for managing a HAN in accordance with one or more embodiments of the present disclosure. Method 320 can be performed, for example, by HAN device 102, ESI 104, ESI 204, gateway device 206, and/or HAN device 202 previously discussed in connection with FIGS. 1 and/or 2. At block 322, method 320 includes receiving operating information associated with a device in a HAN. Receiving operating information can include, for example, receiving operating information associated with a registration of the device in a manner analogous to that previously discussed. Additionally and/or alternatively, receiving operating information can include receiving operating information in response to a service discovery application query and/or a device attributes request, among others, in a manner analogous to that previously discussed.

At block 324, method 320 includes determining a profile associated with the device based, at least in part, on the operating information. Determining a profile can include, for example, determining a profile firmware version associated with the device and/or a participation status of the device in a HAN, in a manner analogous to that previously discussed.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computer-implemented method for managing a home area network, comprising:
receiving operating information associated with a device in a home area network; and
determining a profile associated with the device based, at least in part, on the operating information.

2. The method of claim 1, wherein the operating information associated with the device includes operating information exchanged between the device and an energy service interface, wherein the exchange is associated with a registration of the device with the energy service interface and the operating information associated with the device is received from the energy service interface.

3. The method of claim 1, wherein the operating information is received from the device.

4. The method of claim 1, wherein the method includes:
sending a device attributes request to the device; and
receiving operating information in response to the device attributes request.

5. The method of claim 1, wherein the method includes:
sending a service discovery application query to the device; and
receiving the operating information in response to the service discovery application query.

6. The method of claim 1, wherein the profile includes a participation status of the device in the home area network.

7. The method of claim 1, wherein the profile includes a firmware version associated with the device.

8. The method of claim 1, wherein the method includes displaying the profile.

9. The method of claim 1, wherein the method includes communicating the profile to an additional device.

10. A system for managing a home area network, comprising:
a first device in a home area network; and
a second device in the home area network and configured to:
manage the home area network;
store an identification of a firmware version associated with the first device and an identification of a firmware version associated with the second device; and
store a participation status of the first device in the home area network and a participation status of the second device in the home area network.

11. The system of claim 10, wherein the second device is configured to display the firmware version associated with the second device and the participation status of the second device in the home area network.

12. The system of claim 10, wherein the second device is configured to display the firmware version associated with the first device.

13. The system of claim 10, wherein the second device is configured to communicate the firmware version associated with the second device to the first device.

14. A system for managing a home area network, comprising:
a home area network device; and
a gateway device configured to:
receive a profile associated with the home area network device; and
communicate the profile to an additional device.

15. The system of claim 14, wherein the gateway device is configured to receive the profile upon registration of the home area network device with the gateway device.

16. The system of claim 14, wherein the gateway device is configured to send a request for the profile to the home area network device.

17. The system of claim 14, wherein the gateway device includes a user interface configured to display the profile.

18. The system of claim 14, wherein the additional device is a browser-enabled device.

19. The system of claim 14, wherein the gateway device is configured to communicate the profile to the home area network device.

20. The system of claim 14, wherein the gateway device is configured to:
monitor an upgrade of the profile associated with the home area network device; and
provide a notification associated with the upgrade.
